(19) United States
(12) Patent Application Publication
(10) Pub. No.: US 2010/0147919 A1
(43) Pub. Date: Jun. 17, 2010

(54) Hand-held drive-in tool

(75) Inventor: Ulrich Schiestl, Feldkirch (AT)

Correspondence Address: Davidson, Davidson & Kappel, LLC, 485 7th Avenue, 14th Floor, New York, NY, 10018, US

(73) Assignee: Hilti Aktiengesellschaft, Schaan (LI)

(21) Appl. No.: 12/653,230

(22) Filed: Dec. 10, 2009

(30) Foreign Application Priority Data
Dec. 17, 2008 (DE) DE102008054816.2

(51) Int. Cl. B25C 5/10

(52) U.S. Cl. 227/132

(57) ABSTRACT

A hand-held drive-in tool for fastening elements, having a drive system for a drive-in ram that is displaceably guided in a guide, and that has at least one drive spring element for the drive-in ram that is tensionable by a tensioning device, which is designed as a coil spring and defines a spring axis. A force-application element, which has at least one force-application portion, is fixed in torque-transmitting engagement to at least one end of the drive spring element.

This claims the benefit of German Patent Application No. 10 2008 054 846.2, filed Dec. 17, 2008 and hereby incorporated by reference herein.

The present invention relates to a hand-held drive-in tool. Hand-held drive-in tools of this kind come equipped with a displaceably guided drive-in ram which is used for driving fastening elements into a substrate.

### BACKGROUND

A mechanical drive spring that is tensionable by a tensioning mechanism is used as a driving source for the drive-in ram. In this context, it is advantageous that the mechanical drive spring is inexpensive, so that a drive-in tool of this kind can be manufactured at low cost. Coil springs are frequently used as drive springs for these types of setting tools. They are made of a helically wound wire, the windings collectively forming a cylindrical or conical drive spring which deploys its spring action along a spring axis (respectively, a cylinder or cone axis). The coil spring may be manufactured as a tension or compression spring, depending on whether the resilient movement acts to compress or extend the drive spring. The coil compression spring generally used is composed, on the one hand, of the resilient windings (which actually perform the spring function) and, on the other hand, of the two spring ends, whose function is to transmit the compressive forces acting on the drive spring to the drive spring. In this context, it is important that the compressive forces act centrically, thus, coaxially to the spring axis, on the drive spring, since, otherwise, the compression spring will buckle. This difficulty is generally overcome in that the last spring windings are configured somewhat “close together,” and the last winding is ground, so that a plane contact surface is formed over approximately ¾ of the spring circumference. It is thereby accomplished that the components resting against the plane surface press centrically on the drive spring, so that the drive spring does not buckle upon compression.

A drive-in tool known from U.S. Pat. No. 3,924,692 has a coil spring of this kind as a drive spring, whose last windings are ground in each case. The drive spring is tensionable by a tensioning mechanism that includes an electromotor.

A disadvantage associated with a drive-in tool of this kind is that the steel springs typically used are comparatively heavy. This is disadvantageous for certain applications that entail either a low component weight or a high spring dynamics.

To avoid the disadvantages of steel springs, the World Patent Application WO 2007/142997 A2 discusses using coil springs of a fiber-reinforced plastic material (composite springs) for a drive-in tool. In this case, the composite spring rests by each of its ends on helicoidal endpieces, whereby the compressive force acting on the composite spring is distributed over a relatively large portion of the circumference of the composite spring.

However, this approach has the disadvantage that, when the composite spring is compressed, the pitch, respectively, the angle of inclination of its windings changes. However, due to the altered pitch angle, the last winding no long rests flat against the helicoidal endpiece, since the geometry of the endpiece remains constant independently of the spring load. Thus, the problem again arises that the spring force acts only by punctual contact and thus not centrically on the composite spring.

A further drawback of such composite springs is generally that the manufacturing precludes them from being produced with close together and/or ground spring ends without incurring an unjustifiable expenditure.

### SUMMARY OF THE INVENTION

It is an object of the present invention to provide a drive-in tool of the aforementioned type that will overcome these disadvantages and allow a compressive force to be axially applied in a technically simple manner in the context of drive-in tools, in particular those equipped with composite springs.

The present invention provides a hand-held drive-in tool for fastening elements, comprising a drive system for a drive-in ram that is displaceably guided in a guide and that has at least one drive spring element for the drive-in ram that is tensionable by a tensioning device, which is designed as a coil spring and defines a spring axis. A force-application element, which has at least one force-application portion, is fixed in torque-transmitting engagement to at least one end of the drive spring element. On the one hand, it is thereby accomplished that force is centrically applied to the drive spring without entailing substantial outlay. On the other hand, it is accomplished that a torsional force is also exertable onto at least one of the ends of the drive spring during compression thereof (i.e., the torque transmitted by the force-application element to the spring end has a twisting effect on the drive spring element), the at least one end being loaded to the same degree as the resilient windings of the centrically loaded drive spring. Thus, the same effect is achieved as in the case of steel springs having close together, ground spring windings.

The force-application element advantageously extends from the end of the drive spring element toward the spring axis, the at least one force-application portion, which allows force to be centrically applied relative to the spring axis, being configured at its unattached end portion in the spring axis region.

Moreover, it may be beneficial when the force-application portion of the force-application element has at least two force-application points that reside on one line, the line extending transversely to the spring axis and at a maximum distance to the spring axis of 0 to 20% of the spring diameter. In this context, ‘transversely to the spring axis’ is not only understood to mean extending at a right angle to the spring axis, but may also refer to any orientation of a line that intersects a plane extending through the spring axis. This measure makes it possible for the spring axis region to remain free for other components that must extend centrically through the spring, such as a spindle or a guide rod, for example. Moreover, due to the fact that the force is introduced via two points, the resultant force is applied to the spring axis region, although the force-application element itself does not contact the spring axis region.

In one advantageous embodiment of the present invention, the force-application element has a retaining portion that grips around the end of the drive spring element and is joined via a rotary connection to the force-application portion, an axis of rotation defined by the rotary connection intersecting the spring axis. In response to the loading of the drive spring element, the pitch of the spring winding changes where the force-application element is configured. This, in turn, tilts the force-application element. If the force is then introduced via two force-application portions, the tilting induces a tendency in one of the force-application portions to lift off from its point of support, with the result that force is no longer transmitted via this force-application portion. By using the rotary connection designed as a swivel joint, it is accomplished that the force-application element does not tilt, even though the pitch of the spring windings changes.

The force-application portion advantageously has an annular shape and is disposed coaxially to the spring axis, thereby making it possible for force to be optimally applied to the drive spring element centrically to the spring axis. In this context, annular connotes not only closed annular structures, but also open, for example, C-shaped structures.

In one embodiment that is inexpensive to manufacture, the force-application element is at least partly designed as an elongated strut, which, by the retaining portion configured at the end region facing away from the force-application portion, grips around the end of the drive spring element. The retaining portion may be coupled to the end of the drive spring, for example, via a tensioning connection by a tensioning element, such as a tightening bolt, for example, via a press-fit connection, via a form-locking connection using antirotation elements (transverse pins, fitter keys, grub screws, interlocking geometry) or, for example, integrally, for example, via a bonded joint.

Moreover, it is beneficial when a force-application element is configured at each end of the drive spring element, so that a centric application of force is ensured at both ends of the spring element, and a torsional force may be applied to both ends of the drive spring.

### BRIEF DESCRIPTION OF THE DRAWINGS

The present invention is illustrated in a plurality of exemplary embodiments in the drawing, whose figures show:

FIG. 1: a longitudinal sectional view of a drive-in tool according to the present invention, in its initial position;

FIG. 2: a detail of the drive-in tool in accordance with marking II from FIG. 1;

FIG. 3: a detail of another drive-in tool in accordance with the representation in FIG. 2;

FIG. 4: a detail of another drive-in tool in accordance with FIG. 3, however, in a view parallel to the spring axis;

FIG. 5: a detail of another drive-in tool in accordance with the representation in FIG. 4.

### DETAILED DESCRIPTION

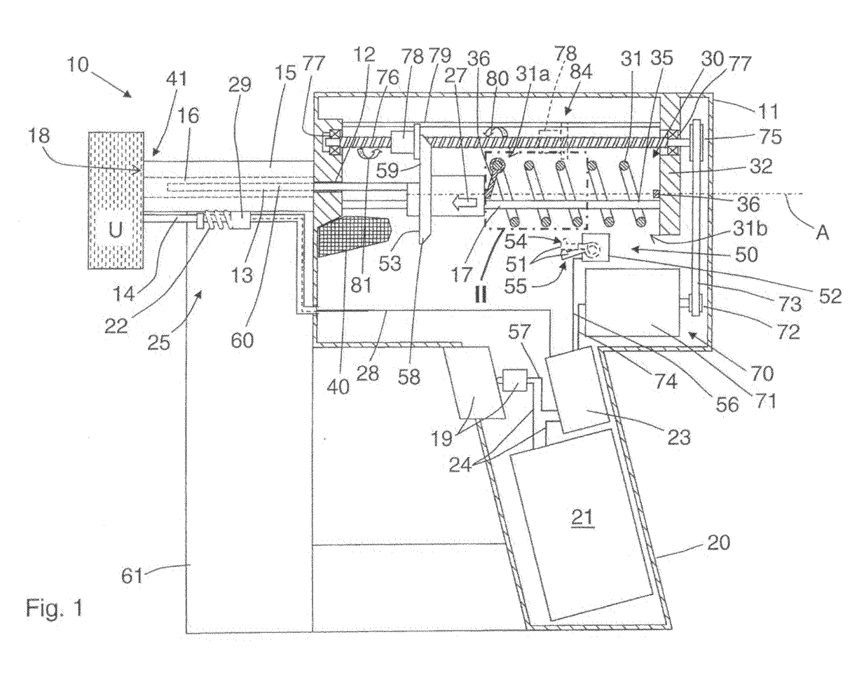

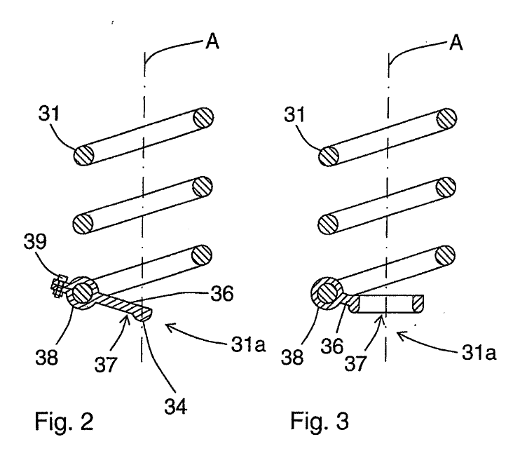

Hand-held drive-in tool 10 illustrated in FIGS. 1 and 2 is electrically powered and has a housing 11 and, located therein, a drive system, denoted as a whole by 30, for a drive-in ram 13 that is displaceably guided in a guide 12 and which, in addition, is guided by a guide portion 35 on a first guide element 17. Drive system 30 includes a drive spring element 31 that extends along a spring axis A and is braced by one first end 31a against drive-in ram 13 and by a second end 31b against a point of support 32 on housing 11. As is apparent from FIG. 2, configured for this purpose at both of its ends 31a, 31b, drive spring element 31 has force-application elements 36 that each grip by a retaining portion 38 formed at first end regions thereof around one end 31a, 31b of drive spring element 31 and are fixed thereto in torque-transmitting engagement. In the specific embodiment shown in FIG. 2, retaining portion 38 is clamped tightly to drive spring element 31 by a screw means 39. Configured in each case at the free end regions of force-application elements 36 facing away from the first end region are force-application portions 37 that reside in the region of spring axis A. In accordance with FIG. 2, force-application portion 37 is crown shaped in the end portion thereof, resides in spring axis A and forms the contact surface for resting against drive-in ram 13, respectively for point of support 32 (force-application portion 37 toward point of support 32 not shown in FIG. 2). Through the use of force-application element 36, force may be axially introduced and output; a torsional moment, which corresponds precisely to the torsional moment acting in the remainder of the spring, being transmittable by the torque-transmitting connection to end 31a, 31b of drive spring element 31. As a result, the spring, to which force is applied, is always in a mechanical state of equilibrium, so that it does not buckle.

Adjoining the end of guide 12 disposed in drive-in direction 27 is a muzzle part 15 having a drive-in channel 16 extending coaxially to guide 12, for fastening elements 60. Projecting laterally from muzzle part 15 is a fastening-element magazine 61, in which fastening elements may be stored.

In addition, drive-in tool 10 has a handle 20. Configured thereon is a trigger switch 19 for triggering a drive-in operation by drive-in tool 10. Also located in handle 20 is a power supply denoted as a whole by 21, via which drive-in tool 10 is supplied with electrical energy. In the present case, power supply 21 contains at least one accumulator. Power supply 21 is connected via electrical supply lines 24 both to an electrical control unit 23, as well as to trigger switch 19. In addition, trigger switch 19 is connected via a switch lead 57 to control unit 23.

Configured at muzzle part 15 of drive-in tool 10 is a contact-pressure element 14, designed as a contact-pressure sensor, of a safety device 25, via which an electrical contact-pressure switch 29 of safety device 25, that is electrically connected via a switching means lead 28 to control unit 23, is actuable. Electrical contact-pressure switch 29 transmits an electrical signal to control unit 23, as soon as drive-in tool 10 is pressed via a muzzle 18 of muzzle part 15 against a workpiece U, as is apparent from FIG. 1, and thereby ensures that drive-in tool 10 may only be triggered when it has been properly pressed against a workpiece U. For this purpose, contact-pressure element 14 is slidingly displaceable along an axis of motion extending in parallel to drive-in channel 16 and between an initial position and a contact-pressure position (not shown in the figures). In this context, contact-pressure element 14 is acted upon elastically via a spring element 22 in the direction of its initial position.

In addition, a tensioning device, denoted as a whole by 70, is located on drive-in tool 10. This tensioning device 70 includes an electrically operated motor 71 which is adapted for driving a threaded spindle 76 mounted on two bearings 77 rotationally, but otherwise not displaceably, in housing 11. Motor 71 is electrically connected via a second control line 74 to control unit 23 and may be set into operation via the same, for example, when contact-pressure switch 29 is actuated by contact-pressure element 14 in response to a pressing operation, or when drive-in tool 10 is lifted off again from a tool U following a drive-in operation. Motor 71 is switched in a way that permits operation in either of the two possible directions of rotation. Seated on an output shaft of motor 71 is an output wheel 72 that is coupled via a transmission element 73 to a spindle wheel 75 of threaded spindle 76 in order to impart a rotary motion to threaded spindle 76 during operation of motor 71. Transmission element 71 is designed, for example, as a belt, toothed belt, chain, cardan shaft, thrust rod or toothed wheel. Motor 71 is mounted with its output shaft axis in parallel to the axis of rotation of threaded spindle 76, it being located between two planes defined by the end faces of threaded spindle 76. Guided on threaded spindle 76 is a traveling nut 78 designed as a circulating-ball nut that engages with the thread of threaded spindle 76. Traveling nut 78 is guided in a torsionally fixed manner, but axially displaceably via a second guide element 79, so that a rotation of threaded spindle 76 produces an axial movement of traveling nut 78. In response to a movement counter to drive-in direction 27, traveling nut 78 travels against a limit stop 59, designed as a projection, of drive-in ram 13 (see, in particular, FIG. 1), which may be thereby co-moved with traveling nut 78 and moved into its setting-ready position. In the process, drive spring element 31 may be displaced from its tension-relieved position to its tensioned position (see FIG. 3).

To hold drive-in ram 13 in its drive-in ready position (not shown in the figures), a locking device, denoted as a whole by 50, is provided, which has a pawl 51 that engages in a locking position 54 (shown in broken lines) on a locking surface 53 at a projection 58 of drive-in ram 13 and holds the same in position against the force of drive-spring means 31. Pawl 51 is supported on a servomotor 52 and is displaceable via the same into a release position 55 illustrated in FIG. 1. Servomotor 52 communicates via an electrical first control line 56 with control unit 23 which transmits control commands to servomotor 52.

If drive-in tool 10 is pressed against a workpiece U, as is apparent from FIG. 1, control unit 23 is then first placed in setting readiness via contact-pressure element 14 and electrical contact-pressure switch 29, and a switching command is sent to motor 71, which, via output wheel 72, transmission element 73 and spindle wheel 75, sets threaded spindle 76 in rotation in the direction of rotation of first arrow 80. Due to the rotation of threaded spindle 76, traveling nut 78 guided thereon is axially displaced counter to drive-in direction 27 and moved from its first end position (not shown in the figure) at the nozzle-side end of threaded spindle 76 into its second end position 84 (see traveling nut 78 indicated by a broken line in FIG. 1). In the process, traveling nut 78 runs against limit stop 59 of drive-in ram 13 and moves the same counter to drive-in direction 27 up to its setting-ready position in which pawl 51 of locking device 50 automatically engages on locking surface 53 at projection 58 of drive-in ram 13. In the process, drive spring element 31 is tensioned and displaced from its tension-relieved position to its tensioned position (not shown in the figures).

As soon as pawl 51 of locking device 50 engages on locking surface 53 at drive-in ram 13, and locking device 50 is situated in its locking position 54 (not shown in the figures), control unit 23 receives a signal to this effect, whereupon control unit 23 switches motor 71 to its second direction of rotation. At this point, via output wheel 72, transmission element 73 and spindle wheel 75, motor 71 sets threaded spindle 76 into rotation in the direction of rotation of second arrow 81. Due to the rotation of threaded spindle 76, traveling nut 78 guided thereon is axially displaced in drive-in direction 27 and moved from its second end position near locking device 50 (see traveling nut 78 indicated by a broken line in FIG. 1) into its first end position at the nozzle-side end of threaded spindle 76.

If trigger switch 19 is then actuated by an operator, locking device 50 is then moved to its release position 55 via control unit 23; via servomotor 52, pawl 51 lifting off of locking surface 53 at drive-in ram 13 by a pivoting movement (not shown in FIG. 1).

Drive-in ram 13 is then moved by drive spring element 31 of drive system 30 in drive-in direction 27, a fastening element 60 being driven into workpiece U. In the process, drive-in ram 13 is braked at the end of the drive-in path by a damping element 40, before it is able to bump against traveling nut 78, in order not to damage the same. For this purpose, this at least one damping element 40 is spaced at an axial distance from a first limit stop of drive-in ram 13 cooperating therewith that is smaller than an axial distance of traveling nut 78 in its first end position to limit stop 59 of drive-in ram 13 opposite traveling nut 78.

To displace drive-in ram 13 to the drive-in ready position and to tension drive spring element 13 at the end of a drive-in operation when drive-in tool 10 is again lifted off from workpiece U or, at the latest, in the case of a repeated pressing of drive-in tool 10 against a workpiece U, tensioning device 70 is activated once again via control unit 23, and the previously described operation is repeated.

The drive-in tool illustrated in a detail in FIG. 3 differs from drive-in tool 10 illustrated in FIGS. 1 and 2 only in that force-application element 36 has a different form. Thus, in this case, retaining portions 38 of force-application elements 36 are each formed as closed rings that are each bonded by ends 31a, 31b of drive spring element 31 (second end 31b not shown in FIG. 3, but identical in design). In addition, force-application portions 37 have an annular design and are essentially positioned coaxially to spring axis A (i.e., the ring axis is disposed coaxially to spring axis A). With regard to the other embodiment of the drive-in tool in accordance with FIG. 3, reference is made to the preceding description of FIG. 1 in its entirety.

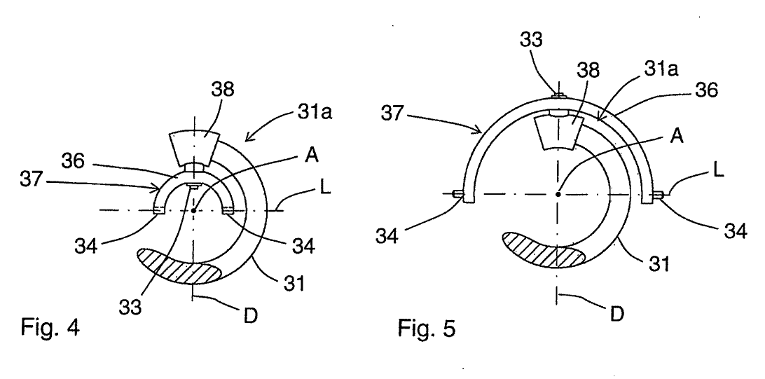

The drive-in tool illustrated in a detail in FIG. 4 differs, inter alia, from drive-in tool 10 illustrated in FIG. 3 in that force-application portions 37 of force-application elements 36 are not designed as closed rings, but as semicircular elements. In this context, semicircular force-application portions 37 span a diameter that is smaller than that of drive spring element 31. At both of its ends, each force-application portion 37 has a force-application point 34. Force-application portion 37 is braced by both force-application points 34 against the housing (11 in FIG. 1) or the drive-in ram (13 in FIG. 1). Both force-application points 34 reside on one line L which intersects spring axis A. In addition, annular retaining portions 38 of force-application element 36, which are fixed to one end 31a, 31b of drive spring element 31 (second end 31b not shown in FIG. 4, but identical in design), respectively, are joined via a rotary connection 33 to force-application portion 37.

By employing rotary connection 33, the force-application element does not tilt in response to the loading of drive spring element 31, even though the pitch of the spring windings changes due to the compression of drive spring element 31. Because force-application element 36 does not tilt, it is ensured that both force-application points 34 of force-application element 36 always remain uniformly braced against housing 11, respectively drive-in ram 13, even during compression of drive spring element 31, whereby it is ensured, in turn, that the line of action of the resultant forces acting on force-application portions 37 always remain in the region of spring axis A.

With regard to the other embodiment of the drive-in tool in accordance with FIG. 4, reference is made to the description of FIG. 1 in its entirety.

The drive-in tool illustrated in a detail in FIG. 5 differs from drive-in tool 10 illustrated in FIG. 4 merely in that semicircular force-application portions 37 of force-application elements 36 span diameters that are greater than the diameter of drive spring element 31. In the case of this specific embodiment as well, each of force-application portions 37 has one force-application point 34 at each of its two ends. Force-application portion 37 is braced by both force-application points 34 against the housing (11 in FIG. 1) or the drive-in ram (13 in FIG. 1). Both force-application points 34 again reside on one line L which intersects spring axis A. In addition, annular retaining portions 38 of force-application element 36, which are fixed to one end 31a, 31b of drive spring element 31 (second end 31b not shown in FIG. 5, but identical in design), respectively, are likewise joined via a rotary connection 33 to force-application portion 37. With regard to the other embodiment of the drive-in tool in accordance with FIG. 5, reference is made to the description of FIGS. 1 and 4 in their entirety.

What is claimed is:

1. A hand-held drive-in tool for fastening elements, comprising:
a drive system for a drive-in ram displaceably guided in a guide and having at least one drive spring element for the drive-in ram, the at least one drive spring element being tensionable by a tensioning device and designed as a coil spring and defining a spring axis; and
a force-application element having at least one force-application portion and being fixed in torque-transmitting engagement to an end of the drive spring element.

2. The drive-in tool as recited in claim 1 wherein the force-application element extends from the end of the drive spring element toward the spring axis, and the at least one force-application portion being configured at an unattached end portion in the region of the spring axis.

3. The drive-in tool as recited in claim 1 wherein the force-application portion of the force-application element has at least two force-application points residing on one line, the line extending transversely to the spring axis and at a maximum distance to the spring axis of 0 to 20% of the spring diameter.

4. The drive-in tool as recited in claim 1 wherein the force-application element has a retaining portion gripping around the end of the drive spring element and is joined via a rotary connection to the force-application portion, an axis of rotation being defined by the rotary connection intersecting the spring axis.

5. The drive-in tool as recited in claim 1 wherein the force-application portion has an annular shape and is disposed coaxially to the spring axis.

6. The drive-in tool as recited in claim 1 wherein the force-application element is at least partly designed as an elongated strut, the elongated strut, by a retaining portion configured at the end region facing away from the force-application portion, gripping around the end of the drive spring element.

7. The drive-in tool as recited in claim 1 wherein a further force-application element is configured at a further end of the drive spring element.
